(19) United States
(12) Patent Application Publication
(10) Pub. No.: US 2026/0106526 A1
(43) Pub. Date: Apr. 16, 2026

(54) ELECTRIC MOTOR OPERATING METHOD

(71) Applicant: Oleksandr I WERSHKOWSKYI, Kyiv (UA)

(72) Inventor: Oleksandr I WERSHKOWSKYI, Kyiv (UA)

(21) Appl. No.: 19/112,725

(22) PCT Filed: Sep. 19, 2023
(86) PCT No.: PCT/UA2023/000045

§ 371 Date: Mar. 18, 2025

(30) Foreign Application Priority Data
Sep. 19, 2022 (UA) A 2022 03430

(51) Int. Cl. H02K 21/02; H02P 31/00

(52) U.S. Cl. CPC H02K 21/022; H02P 31/00; H02P 2207/01; H02P 2207/055

(57) ABSTRACT

The invention relates to the field of electrical engineering, and more particularly to electric motors, and can be used in adaptive electric drive designs, for example, for electric vehicles. Claimed is an operating method of an electric motor in which a rotating magnetic field is excited in a rotor or in a stator, according to which the radial position of a magnetic field source (3) in relation to the axis of rotation (6) of a disc rotor (2) is adjusted according to the speed of rotation of a shaft (4) of the rotor and/or the torque on the rotor shaft (4) while the electric motor is in operation.

### RELATED APPLICATIONS

At least one specification heading is required. Please delete this heading section if it is not applicable to your application. For more information regarding the headings of the specification, please see MPEP 608.01(a).

### FIELD OF THE INVENTION

The invention relates to the field of electrical engineering, in particular to electric motors, and can be used in adaptive electric drive designs, such as in electric vehicles.

### BACKGROUND OF THE INVENTION

A known method of operation of electric motors that consist of a movable rotor, which in some cases is called an “anchor”, and a stator which is a stationary part of electric machines, where the source of the magnetic field, for example windings, is located at a fixed distance from the axis of rotation of the rotor, and the rotating magnetic field is created by the periodical flow of electric current through the windings of the stator or rotor or both at a given frequency.

The known method does not allow the creation of electric motors with the ability to adapt torque depending on operating conditions since the decrease in frequency of current flow through the windings of the electric motor in most cases decreases the torque on the rotor shaft.

At the same time, in machinery a need often arises for electric motors with low rotation speeds (from several to several tens of revolutions per minute) without the use of mechanical gearboxes and the maximum possible torque.

One of the ways to reduce the speed of rotation of the rotor of an electric motor is to implement a magnetic system with the configuration of the indented surface configuration and the winding circuit of a stator with a different number of poles on the stator, thus creating the electromagnetic reduction effect.

Also known is a unipolar machine, containing a double stator and a disk rotor separated by air gaps, the stator consists of electromagnets located concentrically at the same distance from the center of rotation of the rotor and placed at equal radial angles with poles orthogonal to the disk rotor, and the rotor consists of permanent magnets of opposite polarity to the stator electromagnets with a similar angular orientation.

The design features of electrical machines of this type do not allow their efficient operation in high-speed mode, since an increase in the switching speed of the windings leads to significant inductive losses in the stator material and does not allow operation in a wide range of torques and angular velocities.

### SUMMARY OF THE INVENTION

The purpose of the proposed invention is to create a new method of operation of an electric motor with a disk rotor, allowing operation in a wide range of torques and angular velocities.

For this purpose, a method of operating an electric motor with excitation of a rotating magnetic field in the rotor or in the stator, wherein the radial location of the source of the magnetic field relative to the axis of rotation of the disk rotor is changed depending on the rotation speed or on the moment of resistance on the rotor shaft or both during operation of the electric motor.

In addition, the above-mentioned radial arrangement is achieved by mechanically moving the magnetic field source in the radial direction.

In addition, the above-mentioned radial arrangement is changed by connecting to the current source the stator windings of electromagnets located at different radial distances from the rotor rotation axis.

In addition, changing the radial location of the magnetic field source is used in brushless electric motors with a disk rotor.

In addition, changing the radial location of the magnetic field source is used in asynchronous electric motors with a disk rotor.

In addition, changing the radial location of the magnetic field source is used in brushed electric motors with a disk rotor.

In addition, changing the radial location of the magnetic field source is used in outrunner-type electric motors with an external rotor.

### BRIEF DESCRIPTION OF DRAWINGS

The essence of the invention and the method of operation of the electric motor are explained by the drawings, where

FIG. 1 schematically depicts the principle of its application;

FIG. 2 shows the design of a rotor with interaction elements in the form of closed loops in the case of using the method in an asynchronous electric motor;

FIG. 3 shows the placement of the magnetic field source in the version of using an outrunner-type rotor.

The following designations are used in the figures: 1-stator, 2-disk rotor, 3-magnetic field source in the initial position at a distance R1, 4-shaft, 5-bearing, 6-rotation axis, 7-interaction element, 8-position of magnetic field source 3 at a distance Rz, 9-housing, 10-closed electric circuit, 11-rotor window, 12-rotor of the outrunner-type motor.

### DETAILED DESCRIPTION OF THE INVENTION

The above-mentioned feature: “change in the radial location of the magnetic field source during the operation of the electric motor” is a significant difference that corresponds to such a criterion of the invention as novelty. The new essential feature is not known from the patent and technical literature. The use of the above-mentioned essential features together with the known properties of the prototype of the claimed invention allows for the multiple implementations of the stated task, which is the basis for the conclusion on the compliance of the presented technical solution with the invention criterion of industrial applicability.

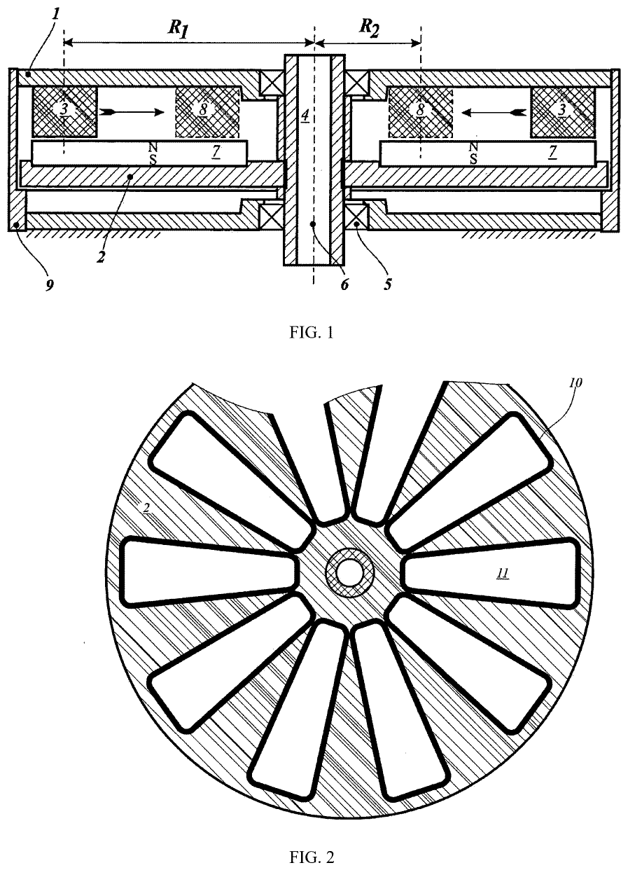

The operating mode of an electric motor can be explained using the example in FIG. 1.

In this case, the rotational magnetic field is excited in the stator 1 using a magnetic field source 3 located at a radial distance Ri from the axis 6.

If necessary, during the operation of the electric motor, the radial distance Ri of the location of the magnetic field source 3 to the rotation axis 6 is changed to the value Rz depending on the rotation speed and/or the moment of resistance on the shaft 4.

The change in the radial distance within the range from Ri to Rz can occur by mechanically moving the magnetic field source 3 in the radial direction or by connecting the stator windings 1, which produce a rotating magnetic field and are located at a radial distance Rz from the axis 6 with the simultaneous disconnection of similar windings located at a radial distance Rz. In addition, changing the radial location of the magnetic field source 3 is used in brushless electric motors with a disk rotor.

In this case, permanent magnets are used as interaction elements 7.

In addition, changing the radial location of the magnetic field source 3 is used in asynchronous electric motors with a disk rotor, shown in FIG. 2.

In this case, closed electrical circuits 10 are used as interaction elements, and windows 11 of the corresponding configuration are made in the rotor.

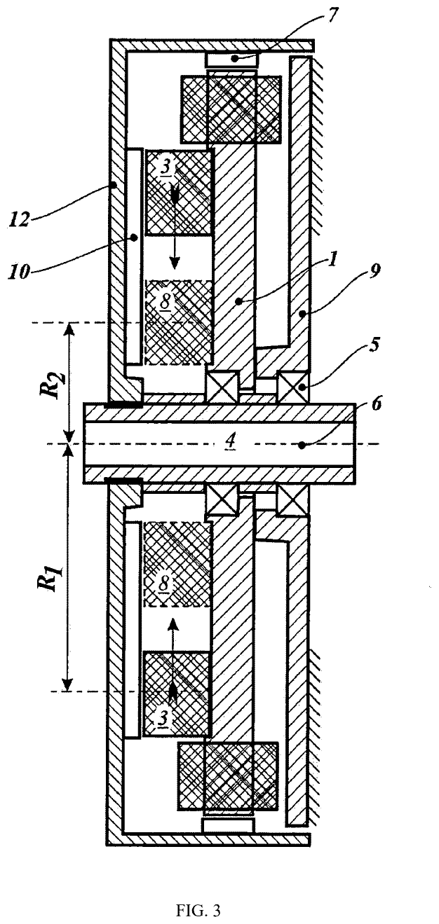

In addition, changing the radial location of magnetic field sources 3 is used in brushed electric motors with a disk rotor. In this case, the interaction elements 7 are located in the stator, and the source of the magnetic field is in the disk rotor, and in this case, electromagnets can be used as interaction elements 7. In addition, changing the radial location of the magnetic field source is used in outrunner-type electric motors with an external rotor 12, as shown in FIG. 3. In this case, the source 3 of the magnetic field is located in the stator, and additional circuits 10 are located on the side disk wall of the outrunner-type rotor 12.

The electric motor in FIG. 1, implemented according to the proposed method, can operate in at least three modes, namely, in the maximum torque mode, in the maximum rotation speed mode, and in the optimal consumption mode.

### Maximum Torque Mode

When the source of magnetic field 3 is located at a maximum distance Ri from the axis 6, a rotating magnetic field is formed, located on the periphery of the rotor 2, and it creates a maximum torque acting at a distance Ri from the axis of rotation 6 interacting with the corresponding elements 7 (permanent magnets, electromagnets) or circuits 10.

In this case, the angular velocity of rotor 2 may be as low as one revolution per minute or less.

### Maximum Rotation Speed Mode

When moving the source of magnetic field 3 and placing it at a minimum distance Ri from axis 6, a rotating magnetic field is formed, which interacts with the corresponding elements 7 or contours 10 and creates a torque acting at a minimum distance from the axis of rotation 6. In this case, the speed of rotation of rotor 2 is the highest possible.

### Optimal Consumption Mode

When the source of magnetic field 3 moves a distance of 0.5(Ri+R2) from the axis 6, a rotating magnetic field is formed in the central zone of rotor 2, which interacts with the corresponding elements 7 or with the closed contours 10 of the rotor and creates a torque acting at an average distance from the axis of rotation 6. In this case, the 6 angular velocity of rotor 2 is average for the corresponding torque.

The operating modes of an electric motor are implemented in a similar manner when the method is used in brushed, asynchronous, and brushless motors with a disk rotor or with an outrunner-type rotor.

In this case, the change in the location of the source of the rotating magnetic field can occur by connecting the corresponding windings of the stator 1 to the current source, which can be located at different distances Ri and R2 from the axis 6 of rotation of the shaft 4.

1. A method of operation of an electric motor with excitation of a rotating magnetic field in a stator (1) or in a disk rotor (2), wherein a radial location of a magnetic field source (3) relative to a rotation axis (6) of the disk rotor (2) is changed depending on a rotation speed or on a moment of resistance on a rotor shaft (4) or both the rotation speed and the moment of resistance during operation of the electric motor.

2. The method according to claim 1 wherein the above-mentioned radial location is changed by mechanically moving the magnetic field source (3) in a radial direction.

3. The method according to claim 1 wherein the above-mentioned radial location is changed by connecting windings of electromagnets of the stator (1) that are located at different distances from the rotation axis (6) to a current source.

4. The method according to claim 1 wherein the change in the radial location of the magnetic field source (3) is used in brushless electric motors with a disk rotor.

5. The method according to claim 1 wherein the change in the radial location of the magnetic field source (3) is used in asynchronous electric motors with a disk rotor.

6. The method according to claim 1 wherein the change in the radial location of the magnetic field source (3) is used in brushed electric motors with a disk rotor.

7. The method according to claim 1 wherein the change in the radial location of the magnetic field source (3) is used in outrunner-type electric motors with an external rotor.
